(19) United States
(12) Patent Application Publication
(10) Pub. No.: US 2019/0041579 A1
(43) Pub. Date: Feb. 7, 2019

(54) ILLUMINATION DEVICE AND ENDOSCOPE INCLUDING THE SAME

(71) Applicant: OLYMPUS CORPORATION, Tokyo (JP)

(72) Inventors: Bakusui DAIDOJI, Hachioji-shi (JP); Takeshi ITO, Hino-shi (JP)

(73) Assignee: OLYMPUS CORPORATION, Tokyo (JP)

(21) Appl. No.: 16/152,471

(22) Filed: Oct. 5, 2018

Related U.S. Application Data
(63) Continuation of application No. PCT/JP2016/061580, filed on Apr. 8, 2016.

(51) Int. Cl. G02B 6/293; G02B 23/24; F21V 8/00

(52) U.S. Cl. CPC G02B 6/29388; G02B 6/0005; G02B 23/2469

(57) ABSTRACT

An illumination device includes at least four narrow band light sources, primary light combiners that combine narrow band light from at least two of the narrow band light sources, and a secondary light combiner that combines primary combined light combined by the primary light combiners. The device is configured to radiate, as illumination light, secondary combined light combined by the secondary light combiner. The light sources are grouped into groups based on illumination characteristics of the narrow band light so that light sources satisfying a condition for the illumination characteristics are grouped into the same group. The light sources in the same group are connected to the primary light combiners so that the light sources in the same group are distributed to the primary light combiners.

### CROSS-REFERENCE TO RELATED APPLICATIONS

This application is a Continuation Application of PCT Application No. PCT/JP2016/061580, filed Apr. 8, 2016, the entire contents of which are incorporated herein by reference.

### BACKGROUND OF THE INVENTION

### 1. Field of the Invention

The present invention relates to an illumination device.

### 2. Description of the Related Art

Jpn. Pat. Appln. KOKAI Publication No. 2007-41342 discloses a light-combining light source that combines radiated light from light sources in two stages in order to obtain high output and high luminance illumination light. FIG. 12 shows such a light-combining light source 100. The light-combining light source 100 includes light sources 11; lenses 12 respectively arranged correspondingly to the light sources 11; multimode optical fibers 13 into which light radiated respectively from the light sources 11 is brought through the lenses 12; a first fiber combiner 14 (primary light combiner) formed by integrating some of the multimode optical fibers 13; three fiber-combining light source units 1-1, 1-2, and 1-3 including multimode optical fibers 15-1, 15-2, and 15-3 that radiate first combined light that is combined by the first fiber combiner 14; a second fiber combiner 2 (secondary light combiner) formed by integrating the multimode optical fibers 15-1, 15-2, and 15-3; and a multimode optical fiber 3 that is connected to an exit end of the second fiber combiner and radiates second combined light.

In each of the fiber-combining light source units 1-1, 1-2, and 1-3, light radiated from the light sources 11 are combined in the first fiber combiner 14 to become first combined light. The first combined light generated in the fiber-combining light source units 1-1, 1-2, and 1-3 is guided through the multimode optical fibers 15-1, 15-2, and 15-3 and combined in the second fiber combiner 2 to become second combined light. With this configuration, light radiated from light sources are combined in two stages to obtain illumination light with high output and high luminance.

### BRIEF SUMMARY OF THE INVENTION

An illumination device includes at least four narrow band light sources, primary light combiners that respectively combine narrow band light radiated from at least two of the narrow band light sources, and a secondary light combiner that combines primary combined light that is combined by the primary light combiners. The illumination device is configured to radiate, as illumination light, secondary combined light that is combined by the secondary light combiner. The narrow band light sources are grouped into groups based on illumination characteristics of the narrow band light as a grouping reference so that narrow band light sources satisfying a predetermined condition for the illumination characteristics are grouped into the same group. Each of the narrow band light sources belonging to the same group is connected to any one of the primary light combiners so that the narrow band light sources belonging to the same group are distributed to the primary light combiners.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic configuration diagram of an illumination device according to a first embodiment.

FIG. 2 is a perspective view of an example of a light combiner constituting a primary light combiner shown in FIG. 1.

FIG. 3 is a cross-sectional view of an example of a light combiner constituting the primary light combiner shown in FIG. 1.

FIG. 4 is a perspective view of an example of a light combiner constituting a secondary light combiner shown in FIG. 1.

FIG. 5 is a cross-sectional view of an example of a light combiner constituting the secondary light combiner shown in FIG. 1.

FIG. 6 is a cross-sectional view of an example of a light converter shown in FIG. 1.

FIG. 7 is a schematic configuration diagram of an endoscope according to a second embodiment.

FIG. 8 is a timing diagram of radiation of lasers shown in FIG. 7.

FIG. 9 is a schematic configuration diagram of an endoscope according to a third embodiment.

FIG. 10 is a schematic configuration diagram of an optical coupler shown in FIG. 9.

FIG. 11 is a diagram of color space coordinates of the CIE 1976 L*u*v* color system.

FIG. 12 is a diagram showing the light-combining light source disclosed in Jpn. Pat. Appln. KOKAI Publication No. 2007-41342.

### DETAILED DESCRIPTION OF THE INVENTION

### First Embodiment

[Configuration]

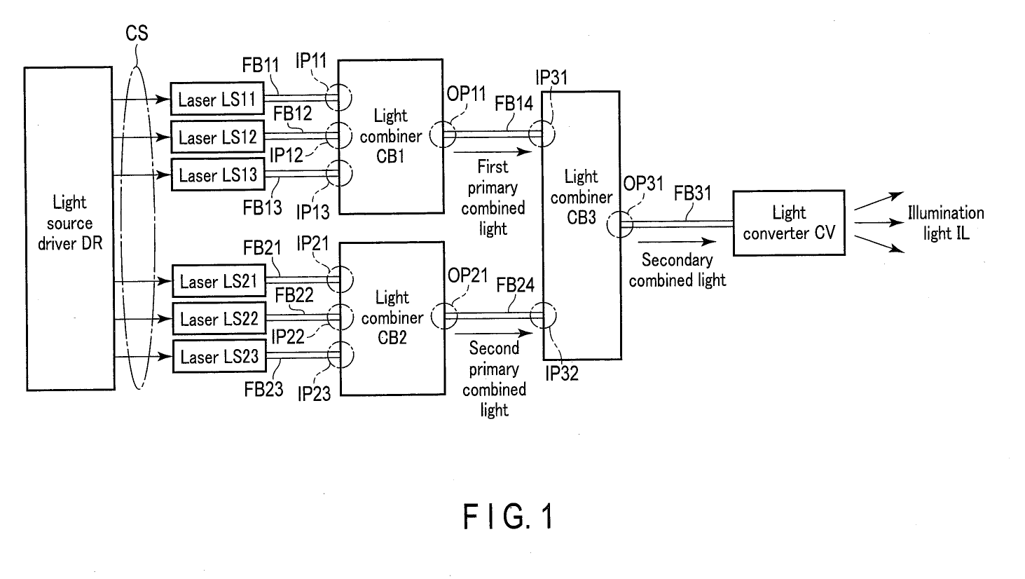

FIG. 1 is a schematic configuration diagram of an illumination device according to a first embodiment. The illumination device includes lasers LS11 to LS13 and LS21 to LS23 that are narrow band light sources; a light source driver DR that controls the drive of the lasers LS 11 to LS13 and LS21 to LS23; optical fibers FB11 to FB13 and FB21 to FB23 respectively connected to the lasers LS 11 to LS13 and LS21 to LS23; light combiners CB1 and CB2 that are primary light combiners connected to the optical fibers FB11 to FB13 and FB21 to FB23; optical fibers FB14 and FB24 respectively connected to the light combiners CB1 and CB2; a light combiner CB3 that is a secondary light combiner connected to the optical fibers FB14 and FB24; an optical fiber FB31 connected to the light combiner CB3; and a light converter CV connected to the optical fiber FB31.

[Lasers LS11 to LS13 and LS21 to LS23 (Narrow Band Light Sources)]

The quantity of radiated light and the emission wavelength of each of the lasers LS11 to LS13 and LS21 to LS23 are as follows. Here, the “quantity of radiated light” indicates the largest quantity of light used in this illumination device. Alternatively, it may be a rated quantity of light of each of the lasers.

Laser LS11: Quantity of radiated light 3W, emission wavelength 445 nm (blue)

Laser LS12: Quantity of radiated light 2W, emission wavelength 525 nm (green)

Laser LS13: Quantity of radiated light 1W, emission wavelength 635 nm (red)

Laser LS21: Quantity of radiated light 3W, emission wavelength 445 nm (blue)

Laser LS22: Quantity of radiated light 2W, emission wavelength 525 nm (green)

Laser LS23: Quantity of radiated light 1W, emission wavelength 635 nm (red)

In order to radiate high-power illumination light IL, the lasers LS11 to LS13 and LS21 to LS23 include narrow band light sources having emission wavelengths of at least two of the same color ranges for three color ranges of a blue range, a green range and a red range. In the present embodiment, two lasers are included for each of the three color ranges of the blue range, the green range, and the red range. However, the number of lasers and the quantity of radiated light are not limited to those described above.

(Color Range)

The above-described blue range, green range, and red range are defined by the following wavelength ranges. Each of the following wavelength ranges is a wavelength range in which the wavelength range from 400 to 700 nm in the visible light range is equally divided into three, and then overlapping ranges (overlap) of 20 nm are provided thereto.

Blue range: 400-510 nm

Green range: 490-610 nm

Red range: 590-700 nm

Furthermore, for example, a wavelength range of 400 nm or less and a wavelength range of 700 nm or more may be allocated to the blue range and the red range, respectively.

[Light Source Driver DR]

The light source driver DR output a light source drive signal CS to each of the lasers LS11 to LS13 and LS21 to LS23, and can independently control ON/OFF, a drive current, a drive system (continuous driving (CW), and pulse drive, etc.) of each of the lasers LS11 to LS13 and LS21 to LS23, etc.) for each of the lasers LS11 to LS13 and LS21 to LS23.

[Optical Fibers FB11 to FB14, FB21 to FB24, and FB31]

The entrance ends of the optical fibers FB11 to FB13 and FB21 to FB23 are optically connected to the lasers LS11 to LS13 and LS21 to LS23, respectively. The exit ends of the optical fibers FB11 to FB13 and FB21 to FB23 are optically connected respectively to a light combiner CB1, which is a first primary light combiner, and a light combiner CB2, which is a second primary light combiner.

The optical fibers FB11 to FB13 and FB21 to FB23 are each composed of, for example, a single line multimode fiber having a core diameter of 50 μm to 200 μm. Although not illustrated, coupling lenses for converging beams of laser light radiated from the lasers LS11 to LS13 and LS21 to LS23 to couple them to the optical fibers FB11 to FB13 and FB21 to FB23 are respectively provided between the lasers LS11 to LS13 and LS21 to LS23 and the optical fibers FB11 to FB13 and FB21 to FB23.

The optical fiber FB11 guides laser light radiated from the laser LS11 and is connected to an entrance port IP11 of the light combiner CB1.

The optical fiber FB12 guides laser light radiated from the laser LS12 and is connected to an entrance port IP12 of the light combiner CB1.

The optical fiber FB13 guides laser light radiated from the laser LS13 and is connected to an entrance port IP13 of the light combiner CB1.

The optical fiber FB21 guides laser light radiated from the laser LS21 and is connected to an entrance port IP21 of the light combiner CB2.

The optical fiber FB22 guides laser light radiated from the laser LS22 and is connected to an entrance port IP22 of the light combiner CB2.

The optical fiber FB23 guides laser light radiated from the laser LS23 and is connected to an entrance port IP23 of the light combiner CB2.

The entrance ends of the optical fibers FB14 and FB24 are optically connected to the light combiners CB1 and CB2, respectively. Both of the exit ends of the optical fibers FB14 and FB24 are optically connected to the light combiner CB3, which is the secondary light combiner.

The optical fiber FB14 is connected to an exit port OP11 of the light combiner CB1, guides first primary combined light that is combined light of the laser light radiated from the lasers LS11 to LS13, and is connected to an entrance port IP31 of the light combiner CB3, which is the secondary light combiner.

The optical fiber FB24 is connected to an exit port OP21 of the light combiner CB2, guides second primary combined light that is combined light of the laser light radiated from the lasers LS21 to LS23, and is connected to an entrance port IP32 of the light combiner CB3, which is the secondary light combiner.

The entrance end of the optical fiber FB31 is optically connected to the light combiner CB3. The exit end of the optical fiber FB31 is optically connected to the light converter CV.

The optical fiber FB31 is connected to an exit port OP31 of the light combiner CB3, guides secondary combined light that is combined light of the first primary combined light and the second primary combined light, and is optically connected to the light converter CV.

The optical fibers FB14, FB24, and FB31 are each composed, for example, of a single line multimode fiber having a core diameter of 100 μm to 400 μm.

[Light Combiners CB1, CB2 (Primary Light Combiners)]

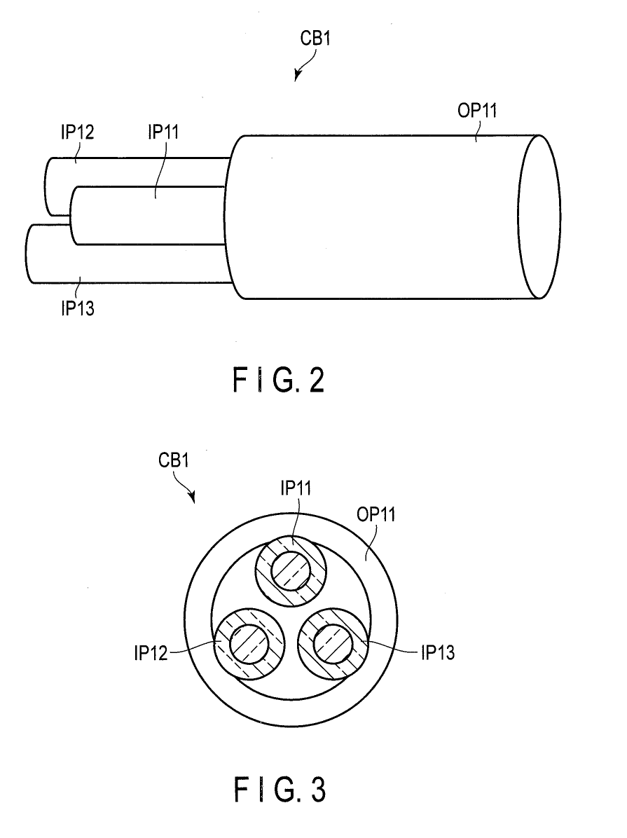

The light combiners C1B and CB2 have a function of combining light that enters the entrance ports IP11 to IP13 and IP21 to IP23. FIGS. 2 and 3 show an example of the light combiner CB1 in the present embodiment. The light combiner CB2 also has the same configuration. In the present embodiment, the light combiner CB1 and the light combiner CB2 have substantially the same characteristics. In the embodiments, and the light combiner CB1 will be described representatively.

The light combiner CB1 has three entrance ports IP11 to IP13 and an exit port OP11. The entrance ports IP11 to IP13 are composed, for example, of a single line multimode fiber having a core diameter of 50 μm to 200 μm. The exit port OP11 is composed, for example, of a single line multimode fiber having a core diameter of 100 μm to 400 μm. The core diameter of the exit port OP11 is larger than the core diameter of the entrance ports IP11 to IP13. Also, in a cross section of the light combiner CB1, the core regions of the entrance ports IP11 to IP13 are included in the core region of the exit port OP11.

The light combiner CB1 is fabricated by fusing the cores of the entrance ports IP11 to IP13 and the core of the exit port OP11, thereby the light combiner CB1 has a function of combining light that is guided through the entrance ports IP11 to IP13 and radiating the combined light from the exit port OP11.

This will be explained with reference to FIG. 1 again.

As described above, the light combiner CB1 has three entrance ports IP11 to IP13 and an exit port OP11.

The optical fiber FB11 is connected to the entrance port IP11, and laser light radiated from the laser LS11 is cause to enter the entrance port IP11.

The optical fiber FB12 is connected to the entrance port IP12, and laser light radiated from the laser LS12 is cause to enter the entrance port IP12.

The optical fiber FB13 is connected to the entrance port IP13, and laser light radiated from the laser LS13 is cause to enter the entrance port IP13.

From the exit port OP11A, first primary combined light, which is combined light of the laser light radiated from the lasers LS11 to LS13, is radiated. The exit port OP11 is connected to the optical fiber FB14.

Similar to the light combiner CB1, the light combiner CB2 has three entrance ports IP21 to IP23 and an exit port OP21.

The optical fiber FB21 is connected to the entrance port IP21, and laser light radiated from the laser LS21 is cause to enter the entrance port IP21.

The optical fiber FB22 is connected to the entrance port IP22, and laser light radiated from the laser LS22 is cause to enter the entrance port IP22.

The optical fiber FB23 is connected to the entrance port IP23, and laser light radiated from the laser LS23 is cause to enter the entrance port IP23.

From the exit port OP21, second primary combined light, which is combined light of the laser light radiated from the lasers LS21 to LS23, is radiated. The exit port OP21 is connected to the optical fiber FB24.

[Light Combiner CB3 (Secondary Light Combiner)]

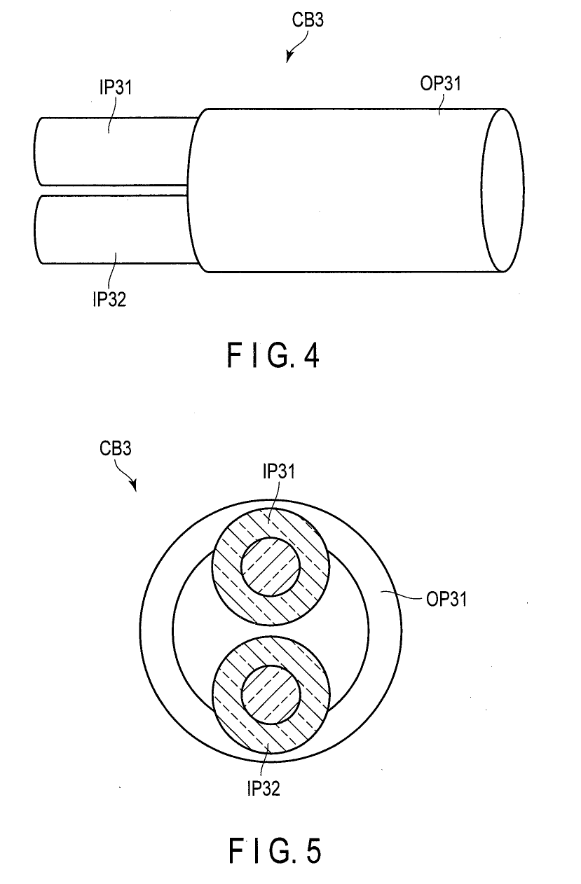

The light combiner CB3 has a function of combining light that enters the entrance ports IP31 and IP32. FIGS. 4 and 5 each show an example of the light combiner CB3 in the present embodiment.

The light combiner CB3 has two entrance ports IP31, IP32 and an exit port OP31. The core diameter of the exit port OP31 is larger than the core diameter of the entrance ports IP31 and IP32. Also, in a cross section of the light combiner CB3, the core regions of the entrance ports IP31 and IP32 are included in the core region of the exit port OP31.

This will be explained referring again to FIG. 1 again.

As described above, the light combiner CB3 has two entrance ports IP31, IP32, and an exit port OP31.

The optical fiber FB14 is connected to the entrance port IP31, and the first primary combined light enters the entrance port IP31.

The optical fiber FB24 is connected to the entrance port IP32, and the second primary combined light enters the entrance port IP32.

From the exit port OP31, secondary combined light, which is combined light of the first primary combined light and the second primary combined light, is radiated. The exit port OP31 is connected to the optical fiber FB31.

[Light Converter CV]

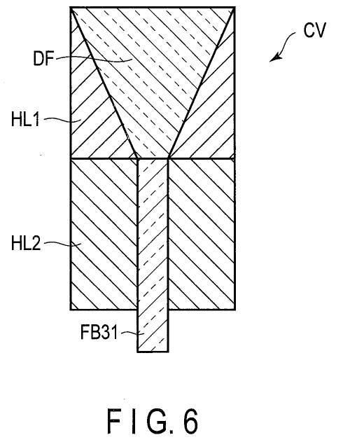

The light converter CV has a function of converting secondary combined light guided through the optical fiber FB31 into a desired light distribution. FIG. 6 shows an example of the light converter CV in the present embodiment. The light converter CV includes a diffusing member DF, a holder HL 1 holding the diffusing member DF, and a holder HL 2 holding the optical fiber FB31. The holder HL 1 and the holder HL 2 are fixed to each other, whereby the diffusing member DF and the optical fiber FB31 are optically connected. The diffusing member DF may be composed, for example, of a transparent member in which alumina particles etc., are dispersed. The diffusing member DF may also be composed of a diffusion plate. Furthermore, the light converter CV may be constituted by using a lens instead of the diffusing member DF, or may be constituted by using a lens and a diffusing member in combination.

[Connection Configuration of Lasers LS11 to LS13 and LS21 to LS23 and Light Combiners CB1, CB2 (Method of Grouping and Distribution)]

In the present embodiment, the lasers LS11 to LS13 and LS21 to LS23 are grouped based on the quantity of radiated light. These are grouped so that lasers LS11 to LS13 and LS21 to LS23 in which the quantities of radiated light are close to each other are grouped into the same group. In addition, lasers LS11 to LS13 and LS21 to LS23 in which the quantities of radiated light are within a predetermined range are grouped into the same group. In this case, for example, Group 1 includes lasers with a quantity of radiated light of 2.5 W or more. Group 2 includes lasers with a quantity of radiated light of 1.5 W or more and less than 2.5 W. Group 3 includes lasers with a quantity of radiated light of less than 1.5 W. In the present embodiment, the laser LS11 and the laser LS21 have the same quantity of radiated light of 3 W, the laser LS12 and the laser LS22 have the same quantity of radiated light of 2 W, and the laser LS13 and the laser LS23 have the same quantity of radiated light of 1 W. Lasers having the same quantity of radiated light are grouped into the same group. Here, “the same quantity of radiated light” means that the quantity of radiated light is the same in terms of design, and lasers whose quantity of radiated light differ by several mW or so due to manufacturing variations, etc., are also regarded as those having the same quantity of radiated light.

In the present embodiment, the lasers LS11 to LS13, and LS21 to LS23 are grouped as follows.

Group 1: Lasers LS11, LS21

Group 2: Lasers LS12, LS22

Group 3: Lasers LS13, LS23

The lasers LS11 and LS21, LS12 and LS22, and LS13 and LS23 belonging to the same group are connected to the light combiners CB1 and CB2 respectively so that the quantity of entering light is dispersed. In other words, each of the lasers LS11 and LS21, LS12 and LS22, and LS13 and LS23 belonging to the same group is connected to any one of the light combiners CB1 and CB2 so that the lasers LS11 and LS21, LS12 and LS22, and LS13 and LS23 belonging to the same group are distributed to the light combiners CB1 and CB2. For example, the lasers LS11 and LS21, LS12 and LS22, and LS13 and LS23 belonging to the same group are distributed to the light combiners CB1 and CB2 so that a difference in quantity of light between the first primary combined light and the secondary primary combined light is equal to or less than a predetermined value. Furthermore, in the present embodiment, the lasers LS11 and LS21, LS12 and LS22, and LS13 and LS23 belonging to the same group are distributed in the same number to the light combiners CB1 and CB2.

In the present embodiment, the lasers LS11 to LS13 and LS21 to LS23 are distributed to the light combiners CB1 and CB2 as shown in Table 1. The difference in quantity of light entering the light combiner CB1 and the light combiner CB2 is the smallest (in this case, the quantities of entering light thereof are substantially equal). In the present embodiment, since the light combiner CB1 and the light combiner CB2 have substantially the same characteristics, the difference in quantity of light between the first primary combined light and the second primary combined light is the smallest (in this case, the quantities of light therebetween are substantially equal).

TABLE 1

| | | | | Input port |
|---|---|---|---|---|
| | | Quantity of | Light | IP31/IP32 of |
| | | radiated | combiner | light combiner |
| Group | Laser | light | CB1/CB2 | CB3 |
| Group | Laser | 3W | Light | Input port IP31 |
| 1 | LS11 | | combiner CB1 | |
| | Laser | 3W | Light | Input port IP32 |
| | LS21 | | combiner CB2 | |
| Group | Laser | 2W | Light | Input port IP31 |
| 2 | LS12 | | combiner CB1 | |
| | Laser | 2W | Light | Input port IP32 |
| | LS22 | | combiner CB2 | |
| Group | Laser | 1W | Light | Input port IP31 |
| 3 | LS13 | | combiner CB1 | |
| | Laser | 1W | Light | Input port I32 |
| | LS23 | | combiner CB2 | |

The number of lasers and/or the quantity of radiated light of the lasers are not limited to those described in the present embodiment. For example, all of the lasers may have different emission wavelengths, all of the lasers may have different quantities of radiated light, the number of lasers in each color range may be different, and lasers in each color range may have different emission wavelengths. For example, a laser in an orange range or a laser in a violet range may be used.

By using a laser as a light source, highly efficient light guiding is possible with a compact system using optical fibers.

The light source is not limited to a laser, but may be a narrow band light source, and may be composed of a narrow band light source such as an LED.

Furthermore, the light source encompass a light source that radiates laser light or LED light having different wavelengths, and a light source that selectively cuts out narrow band light from broad band light emitted from a xenon lamp, etc., by a filter to radiate it.

It is most preferable that laser light is distributed so that the difference in quantity of entering light between the light combiner CB1 and the light combiner CB2, or the difference in quantity of light between the first primary combined light and the second primary combined light is the smallest. However, the present embodiment is not limited thereto. For example, it is sufficient that the difference in quantity of light entering the light combiner CB1 and the light combiner CB2 is 50% or less with respect to the sum of the quantity of light entering the light combiner CB1 and the quantity of light entering the light combiner CB2. It is more desirable that the difference in quantity of entering light be 20% or less. Alternatively, it is sufficient that the difference in quantity of light between the first primary combined light and the second primary combined light is 50% or less with respect to the sum of the quantity of light of the first primary combined light and the quantity of light of the second primary combined light. It is more desirable that the difference in quantity of light be 20% or less. With this difference in quantity of light, the heat generated in the secondary light combiner is dispersed, which allows preventing failure of the secondary light combiner, as will be described later.

[Operation]

1. Lasers LS11 to LS13 and LS21 to LS23 are driven by the light source driver DR, and laser light is simultaneously radiated.

2. The laser light radiated from the lasers LS11 to LS13 is guided through the optical fibers FB11 to FB13, and then brought into the light combiner CB1 from the entrance ports IP11 to IP13. The first primary combined light, which is combined light of the laser light radiated from the lasers LS11 to LS13, is radiated from the exit port OP11 of the light combiner CB1. The first primary combined light is white light.

3. Laser light radiated from the lasers LS21 to LS23 is guided through the optical fibers FB21 to FB23 and then brought into the light combiner CB2 from the entrance ports IP21 to IP23. The second primary combined light, which is combined light of the laser light radiated from the lasers LS21 to LS23, is radiated from the exit port OP21 of the light combiner CB2. The second primary combined light is white light.

4. The first primary combined light is guided through the optical fiber FB21 and then brought into the light combiner CB3 from the entrance port IP31.

5. The second primary combined light is guided through the optical fiber FB22 and then brought into the light combiner CB3 from the entrance port IP32.

6. The secondary combined light, which is combined light of the first primary combined light and the second primary combined light, is radiated from the exit port OP31 of the light combiner CB3. The secondary combined light is white light.

7. The secondary combined light is guided through the optical fiber FB31 and then brought into the light converter CV.

8 The secondary combined light is converted into light with a desired light distribution by the light converter CV and then radiated as illumination light IL.

[Effect]

Grouping is performed with respect to the lasers LS11 to LS13 and LS21 to LS23 based on the quantity of radiated light, and the lasers are connected (arranged) so that the quantity of entering light of the laser light radiated from the lasers LS11 to LS13 and LS21 to LS23 is dispersed, whereby optical loss is dispersed and heat generation is dissipated in an optical path between the entrance port IP31 and the exit port OP31 and in an optical path between the entrance port IP32 and the exit port OP31 in the light combiner CB3. That is, it is possible to prevent heat generated from being concentrated only in a portion of the internal optical path of the light combiner CB3. This allows preventing failure due to heat generation of the light combiner CB3.

### Modification 1 of First Embodiment

This modification is an example of a connection configuration of lasers and light combiners in the case where the number of lasers and the quantity of radiated light are different. In this modification, the number of lasers is changed, and accordingly the number of entrance ports of the light combiners CB1 and CB2 is also changed. Specifically, although not illustrated, the illumination device of this modification includes nine lasers LS11 to LS14 and LS21 to LS25. The laser LS11 and the laser LS21 have the same quantity of radiated light of 3 W and the same emission wavelength of 445 nm. The laser LS12, the laser LS13, the laser LS22, and the laser LS23 have the same quantity of radiated light of 2 W and the same emission wavelength of 525 nm. The laser LS14, the laser LS24 and the laser LS25 have the same quantity of radiated light of 1 W and the same emission wavelength of 635 nm.

In this modification, the lasers LS11 to LS14 and LS21 to LS25 are grouped as follows.

Group 1: Lasers LS11, LS21

Group 2: Lasers LS12, LS13, LS22, LS23

Group 3: Lasers LS14, LS24, LS25

The lasers LS11 to LS14 and LS21 to LS25 are distributed to the light combiners CB1 and CB2 as shown in Table 2.

TABLE 2

| | | Quantity | | | Input port |
|---|---|---|---|---|---|
| | | of | | Light | IP31/IP32 of |
| | | radiated | Wavelength | combiner | light |
| Group | Laser | light | (nm) | CB1/CB2 | combiner CB3 |
| Group | Laser | 3W | 445 | Light | Input port |
| 1 | LS11 | | | combiner CB1 | IP31 |
| | Laser | 3W | 445 | Light | Input port |
| | LS21 | | | combiner CB2 | IP32 |
| Group | Laser | 2W | 525 | Light | Input port |
| 2 | LS12 | | | combiner CB1 | IP31 |
| | Laser | 2W | 525 | Light | Input |
| | LS13 | | | combiner CB1 | port IP31 |
| | Laser | 2W | 525 | Light | Input port |
| | LS22 | | | combiner CB2 | IP32 |
| | Laser | 2W | 525 | Light | Input port |
| | LS23 | | | combiner CB2 | IP32 |
| Group | Laser | 1W | 635 | Light | Input port |
| 3 | LS14 | | | combiner CB1 | IP31 |
| | Laser | 1W | 635 | Light | Input port |
| | LS24 | | | combiner CB2 | IP32 |
| | Laser | 1W | 635 | Light | Input port |
| | LS25 | | | combiner CB2 | IP32 |

The quantity of light entering the light combiner CB1 is 8 W, the quantity of light entering the light combiner CB2 is 9 W, and the difference in quantity of the entering light is 1 W. The difference is approximately 5.9% with respect to the sum of the quantity of light entering the light combiner CB1 and the quantity of light entering the light combiner CB2, i.e., 17 W, which is 20% or less.

[Grouping Method]

Hereinafter, several examples of the grouping method will be described. In the following description, the number of lasers is denoted by K, and lasers are placed in descending order of the quantity of radiated light (i=1, 2, . . . , K). The number of primary light combiners is regarded as L (L≥1). The number of entrance ports of each of the primary light combiners is regarded as being equal to M (M≥2, L×M≥K). The number of secondary light combiners is regarded as 1. The number of entrance ports of the secondary light combiner is regarded as N (N≥2).

### First Example of Grouping Method

1-1: Lasers are sequentially partitioned and grouped into L pieces in descending order of the quantity of radiated light.

1-2: When a remaining laser occurs, the remaining laser is grouped into a group that includes a laser adjacent to the remaining laser.

### Second Example of Grouping Method

1-1: Lasers are sequentially partitioned and grouped into L pieces in descending order of the quantity of radiated light.

1-2: When a remaining laser occurs, the remaining laser is grouped into one group.

### Third Example of Grouping Method

2-1: Lasers having the same quantity of radiated light are grouped into the same group.

2-2: When a laser has a quantity of radiated light that is not the same as those of other lasers, the laser is grouped into the same group of an adjacent layer whose quantity of radiated light is closer to that of the laser, among lasers adjacent to the laser. If the adjacent laser whose output light quantity is close to that of the laser is already grouped, the laser is included in the group.

### Fourth Example of Grouping Method

Lasers are grouped by partitioning, at a substantially equal interval, a light quantity range between the quantity of radiated light of the first laser having the largest quantity of radiated light and the quantity of radiated light of the Kth laser having the smallest quantity of radiated light.

### Fifth Example of Grouping Method

When the quantity of radiated light of the first laser having the largest quantity of radiated light is larger than the sum of the quantities of light of the other lasers, the first laser is directly connected to the secondary light combiner without being grouped and without being connected to the primary light combiner. In this case, L<N.

[Distribution Method]

Basic rule: Lasers belonging to the same group are distributed to primary light combiners so that the difference in quantity of primary combined light radiated from the primary light combiners is small. The “distribution” referred to herein means connecting the lasers so that light radiated from the lasers are brought into the primary light combiners with the quantity of light being dispersed.

### First Example of Distribution Method

The lasers are distributed first from a group including lasers having a larger average quantity of radiated light. (It is assumed that the number of entrance ports of each of the primary light combiners is equal to each other; however, if the number of entrance ports of all of the primary light combiners is not equal, lasers are distributed excluding a primary light combiner having less entrance ports as compared with the other primary light combiners and in which entrance ports are embedded by lasers ahead of the other primary light combiners.)

### Second Example of Distribution Method

The lasers belonging to the same group are distributed to the primary light combiners so that the difference in the number of lasers distributed to the primary light combiners in the same group is equal to or less than 1.

In particular, if the number of lasers included in a group is equal to L or a multiple, the number of remaining lasers is zero, the number of lasers are distributed in the same number to each primary light combiner, and the difference in the number of lasers distributed to the primary light combiners in the same group is zero.

### Third Example of Distribution Method

In lasers included in a group, first, L pieces of lasers or lasers in the number of a multiple of L are distributed in descending order of quantity of radiated light in the same number to each of the primary light combiners, and remaining lasers are distributed in preference to a primary light combiner to which lasers having a small quantity of radiated light are distributed in a first distribution.

### Fourth Example of Distribution Method

To a primary light combiner to which, in a certain group A, lasers are more distributed than the other primary light combiners, lasers in a Group B different from Group A are less distributed than the other primary light combiners.

### Fifth Example of Distribution Method

To a primary light combiner to which, in a certain group A, lasers are distributed so as to have a larger quantity of entering light than quantities of entering light of the other primary light combiners, in a Group B different from Group A, lasers are distributed so as not have a larger quantity of entering light than the quantities of entering light of the other primary light combiners.

### Second Embodiment

[Configuration]

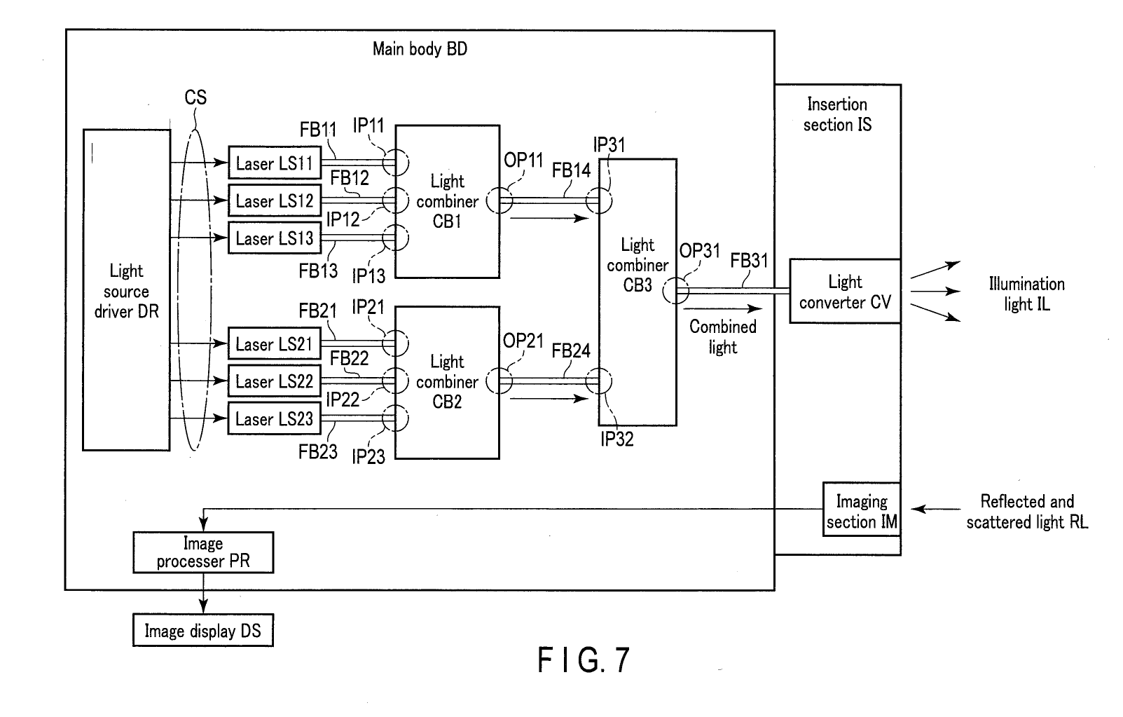

A second embodiment is an endoscope including the illumination device according to the first embodiment. FIG. 7 is a schematic configuration diagram of the endoscope according to the second embodiment. The endoscope includes a main body BD and an insertion section IS, a light converter CV of the illumination device is disposed in the insertion section IS, the elements of the illumination device excluding the light converter CV and an optical fiber FB31 are arranged in the main body BD, and the optical fiber FB31 is disposed inside both the main body BD and the insertion section IS.

The endoscope includes, in addition to the illumination device, an imaging section IM that images an observation object, an image processor PR that processes an imaging signal from the imaging section IM to generate an image of the observation object, and an image display DS that displays the image of the observation object generated by the image processor PR.

In the present embodiment, the lasers LS11 to LS13 and LS21 to LS23 do not simultaneously radiate laser light, and the lasers LS11 to LS13 and LS21 to LS23 in the blue range, the green range, and the red range sequentially radiate laser light. In the present embodiment, the grouping basis and the distribution method for the lasers LS11 to LS13 and LS21 to LS23 are different from those of the first embodiment.

[Imaging Section IM]

The imaging section IM detects reflected and scattered light RL from the observation object to generate an imaging signal. The imaging signal is output to the image processor PR. The imaging section IM is, for example, a CCD imager or a CMOS imager. The imaging section IM in the present embodiment is a monochrome imager including no color filter.

[Image Processor PR]

The image processor PR performs predetermined image processing for a B imaging signal, a G imaging signal, and an R imaging signal sequentially output from the imaging section IM to generate an image of an observation object.

[Image Display DS]

The image display DS displays the image generated by the image processor PR. The image display DS is, for example, a monitor such as a liquid crystal display.

[Connection (Arrangement) Configuration of Lasers LS11 to LS13 and LS21 to LS23 and Light Combiners CB1, CB2]

In the present embodiment, the lasers LS11 to LS13 and LS21 to LS23 are grouped based on radiation timing. The lasers are grouped so that lasers LS11 to LS13 and LS21 to LS23 having the same radiation timing belong to the same group.

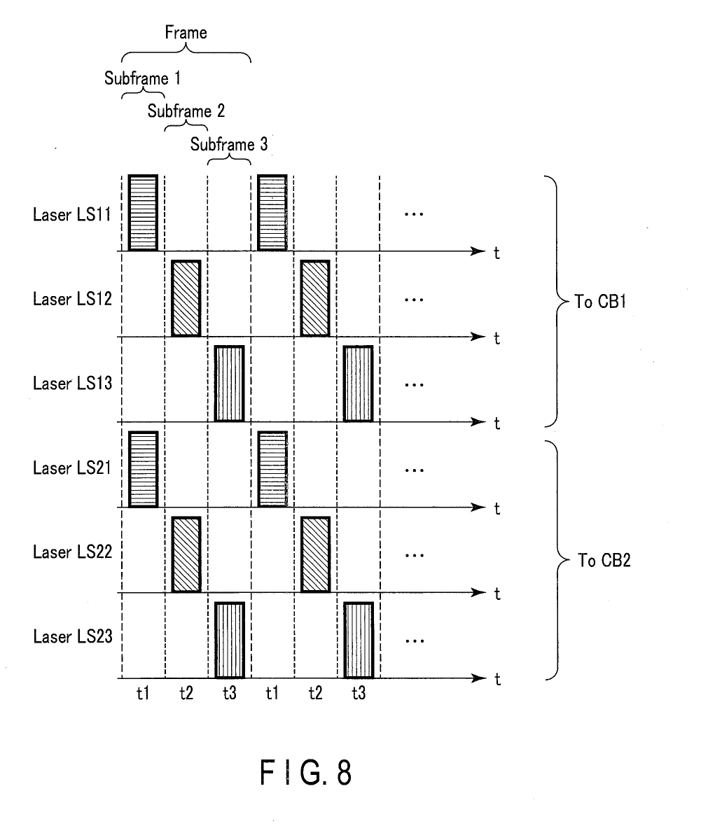

FIG. 8 shows a timing diagram of the radiation of the lasers LS11 to LS13 and LS21 to LS23 in the present embodiment. The laser LS11 and the laser LS21 have the same quantity of radiated light of 3 W and radiate laser light of a blue range at the same timing t1. The laser LS12 and the laser LS22 have the same quantity of radiated light of 2 W and radiate laser light in a green range at the same timing t2. The laser LS13 and the laser LS23 have the same quantity of radiated light of 1 W and radiate laser light of a red range at the same timing t3.

In the present embodiment, the lasers LS11 to LS13 and LS21 to LS23 are grouped as follows.

Group 1: Lasers LS11, LS21

Group 2: Lasers LS12, LS22

Group 3: Lasers LS13, LS23

The lasers LS11 and LS21, LS12 and LS22, and LS13 and LS23 belonging to the same group are distributed to the light combiners CB1 and CB2 respectively so that the quantity of entering light is dispersed, similar to the first embodiment. In other words, the lasers LS11 and LS21, LS12 and LS22, and LS13 and LS23 belonging to the same group are distributed to the light combiners CB1 and CB2 so that a difference in quantity of light between a first primary combined light and a second primary combined light are equal to or less than a predetermined value. Furthermore, in the present embodiment, the lasers LS11 and LS21, LS12 and LS22, and LS13 and LS23 belonging to the same group are distributed in the same number to the light combiners CB1, CB2, respectively.

In the present embodiment, the lasers LS11 to LS13 and LS21 to LS23 are distributed to the light combiners CB1 and CB2 as shown in Table 3. The difference in quantity of light between light entering the light combiner CB1 and light entering the light combiner CB2 is the smallest (in this case, the quantities of light therebetween is substantially equal). Furthermore, in the present embodiment, since the light combiner CB1 and the light combiner CB2 have substantially the same characteristics, the difference in quantity of light between the first primary combined light and the second primary combined light is the smallest (in this case, the quantities of light of them are substantially equal).

TABLE 3

| | | | Quantity | | Input port |
|---|---|---|---|---|---|
| | | | of | Light | IP31/IP32 of |
| | | Radiation | radiated | combiner | light |
| Group | Laser | Timing | light | CB1/CB2 | combiner CB3 |
| Group | Laser | Timing t1 | 3W | Light | Input port |
| 1 | LS11 | | | combiner CB1 | IP31 |
| | Laser | Timing t1 | 3W | Light | Input port |
| | LS21 | | | combiner CB2 | IP32 |
| Group | Laser | Timing t2 | 2W | Light | Input port |
| 2 | LS12 | | | combiner CB1 | IP31 |
| | Laser | Timing t2 | 2W | Light | Input port |
| | LS22 | | | combiner CB2 | IP32 |
| Group | Laser | Timing t3 | 1W | Light | Input port |
| 3 | LS13 | | | combiner CB1 | IP31 |
| | Laser | Timing t3 | 1W | Light | Input port |
| | LS23 | | | combiner CB2 | IP32 |

Note that “having the same radiation timing” encompasses the meaning of having a period of laser light being radiated at the same time. That is, when lasers have a period of laser light being radiated at the same time, it is referred to as “having the same radiation timing”, even if the timing of the start of radiation is not the same time, or the radiation time is different.

Furthermore, the number of lasers and/or radiation timing of the lasers are not limited to those shown in the present embodiment. For example, the number of lasers radiating laser light at each radiation timing is not limited to two. Lasers radiating laser light at the same timing are not necessarily those having the same emission wavelength. For example, a laser in an orange range or a laser in a violet range may be used. In the present embodiment, blue, green, and red laser light is sequentially radiated correspondingly to three subframes, but the number of subframes is not limited to three.

[Operation]

1. Lasers LS11 to LS13 and LS21 to LS23 are driven by the light source driver DR, and laser light in the blue range, green range, and red range are sequentially radiated as shown in FIG. 8.

2. At timing t1, the laser LS11 and the laser LS21 simultaneously radiate laser light in the blue range. The laser light radiated from the laser LS11 is guided through the optical fiber FB11, is brought into the light combiner CB1 from the entrance port IP11, and is radiated from the exit port OP11 of the light combiner CB1. The laser light radiated from the laser LS21 is guided through the optical fiber FB21, is brought into the light combiner CB2 from the entrance port IP21, and is radiated from the exit port OP21 of the light combiner CB2.

3. The laser light radiated from the laser LS11 and the laser light radiated from the laser LS21 are brought into the entrance port IP31 and entrance port IP32 of the light combiner CB3, respectively, and combined light of the laser light radiated from the laser LS11 and the laser light radiated from the laser LS21 is radiated from the exit port OP31.

4. The combined light of the laser light radiated from the laser LS11 and the laser light radiated from the laser LS21 is converted into light with a desired light distribution by the light converter CV and then irradiated as illumination light IL to an observation object.

5. The imaging section IM detects reflected and scattered light RL of the illumination light IL generated by the observation object to generate an imaging signal of a subframe 1.

6. At timing t2, the laser LS12 and the laser LS22 simultaneously radiate laser light in the green range. Combined light of the laser light radiated from the laser LS12 and the laser light radiated from the laser LS22 is converted into light with a desired light distribution by the light converter CV in the same manner as described above and then radiated as illumination light IL and irradiated to the observation object. The imaging section IM detects reflected and scattered light RL of the illumination light IL generated by the observation object to generate an imaging signal of a subframe 2.

7. At timing t3, the laser LS13 and the laser LS23 simultaneously radiate laser light in the red range. Combined light of the laser light radiated from the laser LS13 and the laser light radiated from the laser LS23 is converted into light with a desired light distribution by the light converter CV in the same manner as described above and then radiated as illumination light IL, and irradiated to the observation object. The imaging section IM detects reflected and scattered light RL of the illumination light IL generated by the observation object to generate an imaging signal of a subframe 3.

8. The image processor PR synthesizes the images of the subframes 1 to 3 to generate a color (white) image of one frame. The image display DS displays an image generated by the image processor PR.

[Effect]

Grouping is performed with respect to the lasers LS11 to LS13 and LS21 to LS23 based on the radiation timing, and the lasers are connected (arranged) so that the quantity of entering light of laser light radiated from the lasers LS11 to LS13 and LS21 to LS23 is dispersed, whereby optical loss is dispersed and heat generation is dissipated in an optical path between the entrance port IP31 and the exit port OP31 and in an optical path between the entrance port IP32 and the exit port OP31 in the light combiner CB3. That is, it is possible to prevent heat generated from being concentrated only in a portion of the internal optical path of the light combiner CB3. This allows preventing failure due to heat generation of the light combiner CB3.

### Third Embodiment

[Configuration]

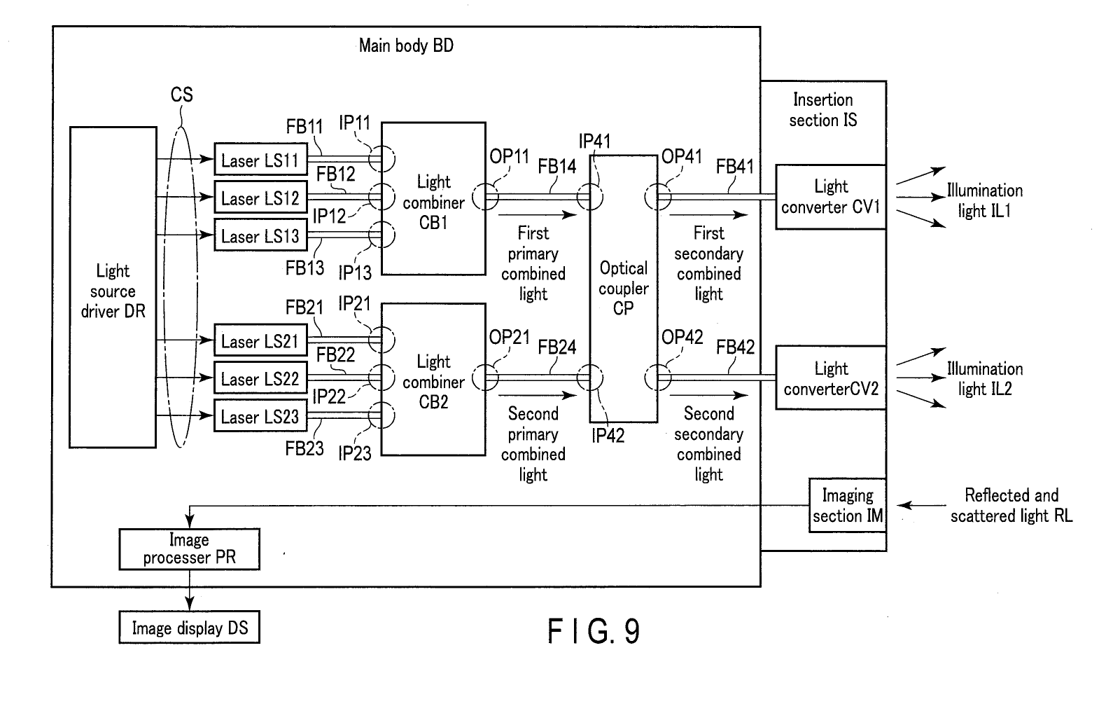

A third embodiment is an endoscope similar to the second embodiment. FIG. 9 is a schematic configuration diagram of the endoscope according to the third embodiment. As compared with the endoscope of the second embodiment, the endoscope of the third embodiment has a configuration in which the light combiner CB3, which is the secondary light combiner of the illumination device, is replaced with an optical coupler CP, and accordingly, the optical fiber FB31 and the light converter CV are replaced with two optical fibers FB41, FB42 and two light converters CV1, CV2. Furthermore, the imaging section IM is composed of a color imager.

[Optical Coupler CP (Secondary Light Combiner, Light-Combining/Branching Section)]

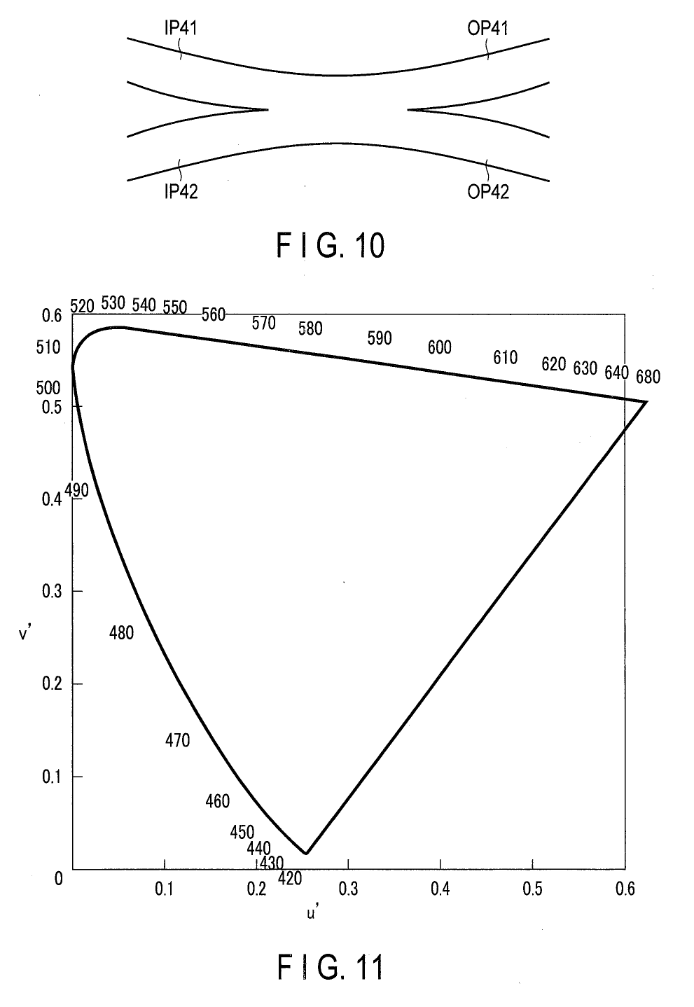

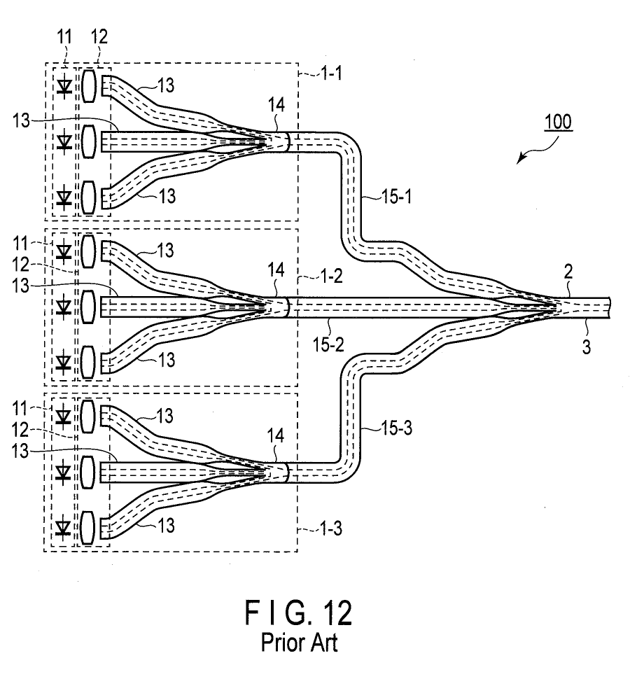

FIG. 10 illustrates an example of an optical coupler CP in the present embodiment. The optical coupler CP has two entrance ports IP41, IP42 and two exit ports OP41, OP42. The optical coupler CP has a function of combining light brought into an entrance port IP41 and light brought into the entrance port IP42 and branching the combined light to the exit port OP41 and the exit port OP42. The optical coupler CP branches the light brought into the entrance port IP41 to the exit port OP41 and the exit port OP42, ideally at a ratio of 1:1, and branches the light brought into the entrance port IP42 to the exit port OP41 and the exit port OP42, ideally at a ratio of 1:1.

This will be explained with reference to FIG. 9 again.

An optical fiber FB14 is connected to the entrance port IP4l, and first primary combined light is brought into the entrance port IP41.

An optical fiber FB24 is connected to the entrance port IP42, and second primary combined light is brought into the entrance port IP42.

First secondary combined light into which the first primary combined light is combined with the second primary combined light is radiated from the exit port OP41.

Second secondary combined light into which the first primary combined light is combined with the second primary combined light is radiated from the exit port IP42.

[Optical Fibers FB41, FB42]

The entrance end of the optical fiber FB41 is connected to the exit port OP41 of the optical coupler CP, and the exit end of the optical fiber FB41 is connected to the light converter CV1. The entrance end of the optical fiber FB42 is connected to the exit port OP42 of the optical coupler CP, and the exit end of the optical fiber FB42 is connected to the light converter CV2. Both the optical fibers FB41 and FB42 have substantially the same characteristics as the optical fiber FB31 of the second embodiment, i.e., the optical fiber FB31 of the first embodiment.

[Light Converters CV1, CV2]

Both of the light converters CV1 and CV2 are disposed at the distal end of the insertion section IS of the endoscope, similar to the light converter CV of the second embodiment. Both the light converters CV1 and CV2 have substantially the same characteristics as the light converter CV of the second embodiment, i.e., the light converter CV of the first embodiment. The light converter CV1 converts first secondary combined light from the optical fiber FB41 into light with a desired light distribution to radiate it as illumination light IL1. The light converter CV2 converts second secondary combined light from the optical fiber FB42 into light with a desired light distribution to radiate it as illumination light IL2.

The third embodiment differs from the second embodiment in the grouping basis and distribution method for the lasers LS11 to LS13 and LS21 to LS23. The lasers LS11 to LS13 and LS21 to LS23 simultaneously radiate laser light similar to the first embodiment. Furthermore, in the present embodiment, the lasers LS11 to LS13 and LS21 to LS23 have the same quantity of radiated light of 1 W.

### Problem to be Solved in Third Embodiment

Even if the branching ratio of the optical coupler CP is designed to be approximately 1:1, the branching ratio may deviate from the design value due to a manufacturing error. For example, when laser light is brought in from the entrance port IP41 of the optical coupler CP, the branching ratio of the exit port OP41 to the exit port OP42 of the optical coupler CP results in a bias of 1.1:0.9. On the other hand, when laser light is brought in from the entrance port IP42 of the optical coupler CP, the branching ratio of the exit port OP41 to the exit port OP42 of the optical coupler CP results in a bias of 0.9:1.1, which is an inverse bias of the branching ratio in the case where laser light is brought in from the entrance port IP41.

At this time, if a color difference exists between the first primary combined light brought in the entrance port IP41 and the second primary combined light brought in the entrance port IP42, a color difference between the first secondary combined light radiated from the exit port OP41 and the second secondary combined light radiated from the exit port OP42 increases. Accordingly, the color difference between the illumination light IL1 radiated from the light converter CV1 and the illumination light IL2 radiated from the light converter CV2 also increases. Consequently, the total illumination light, which is an overlap of the illumination light IL1 and the illumination light IL2, varies in color due to the light distribution, namely, color unevenness occurs in the illumination light, which may adversely affect the observation.

[Configuration of Connection (Arrangement) of Lasers LS11 to LS13 and LS21 to LS23, and Light combiners CB1, CB2]

In the present embodiment, the lasers LS11 to LS13 and LS21 to LS23 are grouped based on the emission wavelengths, and lasers having emission wavelengths included in a predetermined wavelength range are grouped into the same group. In the present embodiment, the predetermined wavelength range is each of the color ranges of the blue range, green range, and red range defined in the first embodiment. That is, narrow band light sources having emission wavelengths included in the same color range are grouped into the same group. Furthermore, in the present embodiment, the laser LS11 and the laser LS21 have the same emission wavelength of 445 nm, the laser LS12 and the laser LS22 have the same emission wavelength of 525 nm, and the laser LS13 and the laser LS23 have the same emission wavelength of 635 nm. Lasers LS having the same emission wavelength are grouped into the same group. Here, the “same emission wavelength” indicates that the emission wavelength is the same in terms of design, and it is assumed that lasers whose emission wavelength is different by several nm or so due to manufacturing variations, etc., also have the same emission wavelength.

In the present embodiment, the lasers LS11 to LS13, and LS21 to LS23 are grouped as follows.

Group 1: Lasers LS11, LS21

Group 2: Lasers LS12, LS22

Group 3: Lasers LS13, LS23

The lasers LS11 and LS21, LS12 and LS22, and LS13 and LS23 belonging to the same group are distributed to the light combiners CB1 and CB2 so that the color difference between the first primary combined light and the second primary combined light is equal to or less than a predetermined value. In other words, the lasers LS11 and LS21, LS12 and LS22, and LS13 and LS23 belonging to the same group are distributed to the light combiners CB1 and CB2 so that the color difference between the illumination light IL1 and the illumination light IL2 is equal to or less than a predetermined value. Furthermore, in the present embodiment, the lasers LS11 and LS21, LS12 and LS22, and LS13 and LS23 belonging to the same group are distributed in the same number to the light combiners CB1 and CB2.

In the present embodiment, the lasers LS11 to LS13 and LS21 to LS23 are distributed to the light combiners CB1 and CB2 as shown in Table 4. The color difference between the first primary combined light and the second primary combined light brought in the optical coupler CP is the smallest (in this case, the colors thereof is substantially equal). Furthermore, in the present embodiment, since the light converter CV1 and the light converter CV2 have substantially the same characteristics, the color difference between the illumination light IL1 and the illumination light IL2 is the smallest (in this case, the colors thereof is substantially equal).

TABLE 4

| | | | Quantity | | Input port |
|---|---|---|---|---|---|
| | | | of | Light | IP31/IP32 of |
| | | Wavelength | radiated | combiner | light |
| Group | Laser | (nm) | light | CB1/CB2 | combiner CB3 |
| Group | Laser | 445 | 1W | Light | Input port |
| 1 | LS11 | | | combiner CB1 | IP41 |
| | Laser | 445 | 1W | Light | Input port |
| | LS21 | | | combiner CB2 | IP42 |
| Group | Laser | 525 | 1W | Light | Input port |
| 2 | LS12 | | | combiner CB1 | IP41 |
| | Laser | 525 | 1W | Light | Input port |
| | LS22 | | | combiner CB2 | IP42 |
| Group | Laser | 635 | 1W | Light | Input port |
| 3 | LS13 | | | combiner CB1 | IP41 |
| | Laser | 635 | 1W | Light | Input port |
| | LS23 | | | combiner CB2 | IP42 |

Here, the color difference in the present embodiment indicates “a difference in color of light”. As a color difference evaluation value, for example, a difference in the center wavelength can be used. A center wavelength λc is defined by the following equation (1), when the quantity of radiated light of the laser is denoted by Pi and the emission wavelength is denoted by λi.

$${λ}_{C} = \frac{{\sum }_{i} {P}_{i} {λ}_{i}}{{\sum }_{i} {P}_{i}} \qquad ( 1 )$$

As another evaluation value of the color difference, for example, a distance of the color space coordinates of the CIE 1976 L*u*v* colorimetric system shown in FIG. 11 may be used. Also, instead of the color difference of illumination light, the difference in the color of reflected light in a representative observation object may be used as a reference. This indicates “a difference in color reproducibility with respect to the observation object”. The difference between the center wavelengths may be 50 nm or less, for example. As the distance of the color space coordinates, for example, the solution of the following equation (2) may be 0.3 or less. If so, as will be described later, the color difference between the illumination light IL1 radiated from the light converter CV1 and the illumination light IL2 radiated from the light converter CV2 is small, which allows providing an endoscope having excellent illumination characteristics in which a color is substantially uniform.

\sqrt{(u*)²+(v*)²} (2)

It is most preferable that the lasers be connected to the light combiners so that the color difference between the first primary combined light and the second primary combined light is the smallest, but the embodiment is not limited thereto. For example, it is sufficient that the lasers of the lasers LS11 to LS13 and LS21 to LS23 included in the same color range are connected respectively to the light combiners CB1 and CB2.

The number of lasers and/or the emission wavelength of lasers are not limited to those described in the present embodiment. For example, all of lasers may have different emission wavelengths. For example, a laser in an orange range or a laser in a violet range may be used. Furthermore, the light source is not limited to a laser, but only has to be a narrow band light source and may be constituted by a narrow band light source such as an LED.

[Operation]

1. Lasers LS11 to LS13 and LS21 to LS23 are driven by the light source driver DR, and laser light are simultaneously radiated.

2. The laser light radiated from the lasers LS11 to LS13 is guided through the optical fibers FB11 to FB13, and then brought into the light combiner CB1 from the entrance ports IP11 to IP13. The first primary combined light, which is combined light of the laser light radiated from the lasers LS11 to LS13, is radiated from the exit port OP11 of the light combiner CB1. The first primary combined light is white light.

3. Laser light radiated from the lasers LS21 to LS23 is guided through the optical fibers FB21 to FB23 and then brought into the light combiner CB2 from the entrance ports IP21 to IP23. The second primary combined light, which is combined light of the laser light radiated from the lasers LS21 to LS23, is radiated from the exit port OP21 of the light combiner CB2. The second primary combined light is white light.

4. The first primary combined light is guided through the optical fiber FB21 and then brought into the optical coupler CP from the entrance port IP41.

5. The second primary combined light is guided through the optical fiber FB22 and then brought into the optical coupler CP from the entrance port IP42.

6. The secondary combined light, which is combined light of the first primary combined light and the second primary combined light, is radiated from the exit port OP41 and the exit port OP42 of the optical coupler CP. The secondary combined light is white light.

7. The secondary combined light is guided through the optical fibers FB41 and FB42 and then brought into the light converters CV1 and CV2.

8 The secondary combined light is converted into light with a desired light distribution by the light converters CV1 and CV2 and then radiated as illumination light IL1 and IL2, and irradiated to an observation object.

9. The imaging section IM detects reflected and scattered light RL of the illumination light IL1 and IL2 generated by the observation object to generate an imaging signal.

10. The image processor PR processes the imaging signal supplied from the imaging section IM to generate an image. The image display DS displays the image generated by the image processor PR.

[Effect]

Grouping is performed with respect to the lasers LS11 to LS13 and LS21 to LS23 based on the emission wavelengths, and the lasers are connected (arranged) to the light combiners CB1 and CB2 so that the color difference between the first primary combined light and the second primary combined light is equal to or less than a predetermined value, which allows reducing the color difference between the illumination light IL1 and the illumination light IL2 to be equal to or less than a predetermined value. This reduces the occurrence of color unevenness of the illumination light and contributes to favorable observation.

### Modification Applicable to Each Embodiment

The number of narrow band light sources is not limited to the number of lasers in the embodiments described herein and may be appropriately modified.

For example, the illumination device may have a configuration that includes at least four narrow band light sources; primary light combiners that respectively combine narrow-band light radiated from at least two of the at least four narrow band light sources; and a secondary light combiner that combines the primary combined light combined by the primary light combiners. As an example, the illumination device may have a configuration in which the laser LS13 and the laser LS23 are omitted in the illumination device of the first embodiment.

Furthermore, the illumination device may have a configuration that includes at least three narrow band light sources; at least one primary light combiner that combines narrow band light radiated from at least two of the at least three narrowband light sources; and a secondary light combiner that combines primary combined light combined by the primary light combiner and narrow band light radiated from a narrow band light source other than the at least two narrow band light sources. For example, the illumination device may have a configuration in which the laser LS13, the laser LS22, and the laser LS23 are omitted, and the light combiner CB2 is further omitted from the illumination device of the first embodiment.

Each of such configurations may have the same advantages as those described in the embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An illumination device comprising:
at least four narrow band light sources;
primary light combiners that respectively combine narrow band light radiated from at least two of the narrow band light sources; and
a secondary light combiner that combines primary combined light that is combined by the primary light combiners,
the illumination device being configured to radiate, as illumination light, secondary combined light that is combined by the secondary light combiner,
the narrow band light sources being grouped into groups based on illumination characteristics of the narrow band light as a grouping reference so that narrow band light sources satisfying a predetermined condition for the illumination characteristics are grouped into the same group, and
each of the narrow band light sources belonging to the same group being connected to any one of the primary light combiners so that the narrow band light sources belonging to the same group are distributed to the primary light combiners.

2. The illumination device according to claim 1, wherein each of the primary light combiners has at least two primary light combiner entrance ports into which the narrow band light radiated from the at least two of the at least four narrow band light sources is brought, and at least one primary light combiner exit port that radiates the primary combined light, and
wherein the secondary light combiner has secondary light combiner entrance ports into which the primary combined light combined by the primary light combiners is brought, and at least one secondary light combiner exit port that radiates the secondary combined light.

3. An illumination device comprising:
at least three narrow band light sources;
at least one primary light combiner that combines narrow band light radiated from at least two of the narrow band light sources; and
a secondary light combiner that combines primary combined light combined by the primary light combiner with narrow band light radiated from a narrow band light source other than the at least two narrow band light sources,
the illumination device being configured to radiate, as illumination light, secondary combined light that is combined by the secondary light combiner,
the narrow band light sources being grouped into at least one group based on illumination characteristics of the narrow band light as a reference so that narrow band light sources satisfying a predetermined condition for the illumination characteristics are grouped into the same group, and
each of the narrow band light sources belonging to the same group being connected to one of the at least one primary light combiner and the secondary light combiner so that the narrow band light sources belonging to the same group are distributed to the at least one primary light combiner and the secondary light combiner.

4. The illumination device according to claim 3, wherein each of the primary light combiners has primary light combiner entrance ports into which the narrow band light radiated from the at least two of the at least three narrow band light sources is brought, and at least one primary light combiner exit port that radiates the primary combined light,
wherein the secondary light combiner has secondary light combiner entrance ports into which the primary combined light combined by the at least one primary light combiner and narrow band light radiated from a narrow band light source other than the at least two narrow band light sources is brought, and at least one secondary light combiner that radiates the secondary combined light.

5. The illumination device according to claim 1, wherein the illumination characteristics are at least one of a quantity of radiated light, an emission wavelength, and radiation timing, and among the narrow band light sources, narrow band light sources with at least one of the quantity of radiated light, the emission wavelength, and the radiation timing being included in a predetermined range are grouped so as to belong to the same group.

6. The illumination device according to claim 5, wherein the grouping reference is the quantity of radiated light of the narrow band light sources, and narrow band light sources having quantities of radiated light included in a predetermined light quantity range are grouped into the same group, or
wherein the grouping reference is the radiation timing of the narrow band light sources, and when narrow band light are sequentially radiated from the narrow band light sources at different light radiation timing, narrow band light sources having the same light radiation timing are grouped into the same group, or
wherein the grouping reference is the emission wavelength of the narrow band light sources, and narrow band light sources having emission wavelengths included in a predetermined emission wavelength range are grouped into the same group.

7. The illumination device according to claim 6, wherein narrow band light sources having emission wavelengths included in the same color range for three color regions of a blue range, a green range, and a red range are grouped into the same group.

8. The illumination device according to claim 5, wherein among the narrow band light sources, narrow band light sources having substantially equal illumination characteristics are grouped into the same group.

9. The illumination device according to claim 6, wherein the narrow band light sources belonging to the same group are distributed to the primary light combiners so that a difference in quantity of the primary combined light is equal to or less than a predetermined value.

10. The illumination device according to claim 6, wherein the narrow band light sources belonging to the same group are distributed to the primary light combiners so that a color difference of the primary combined light is equal to or less than a predetermined value.

11. The illumination device according to claim 6, wherein the narrow band light sources belonging to the same group are distributed to the primary light combiners so that a difference in the number of the narrow band light sources to be distributed in the same group to the primary light combiners is equal to or less than 1.

12. The illumination device according to claim 1, wherein the narrow band light sources include narrow band light sources having emission wavelengths of at least two of the same color ranges.

13. The illumination device according to claim 2, wherein when the number of the secondary light combiner exit ports is only one, the quantity of radiated light of the narrow band light sources, or the radiation timing of the narrow band light sources is selected as the grouping reference in preference to the emission wavelength of the narrow band light sources, or
wherein when the secondary light combiner exit ports are present, the emission wavelength of the narrow band light sources is selected as the grouping reference in preference to the quantity of radiated light of the narrow band light sources or the radiation timing of the narrow band light sources.

14. The illumination device according to claim 6, wherein the narrow band light sources are sequenced in descending order of quantity of radiated light, and the narrow band light sources are sequentially partitioned and grouped into a predetermined number of pieces in descending order of quantity of radiated light, and remaining narrow band light sources are grouped into a group that includes adjacent narrow band light sources of the remaining narrow band light sources.

15. The illumination device according to claim 6, wherein the narrow band light sources are sequenced in descending order of quantity of radiated light; among the narrow band light sources, narrow band light sources having the same quantity of radiated light are grouped into the same group; narrow band light sources not having the same quantity of radiated light as quantities of radiated light of the other narrow band light sources are grouped into the same group to which a narrow band light source, in adjacent narrow band light sources, in which the quantity of radiated light is closer to the quantity of radiated light of the narrow band light sources not having the same quantity of radiated light; and when the narrow band light source having a closer quantity of radiated light is already grouped into a group, the narrow band light sources not having the same quantity of radiated light are grouped into the group.

16. The illumination device according to claim 6, wherein the narrow band light sources are sequenced in descending order of quantity of radiated light, and the narrow band light sources are grouped by partitioning, at a substantially equal interval, a light quantity range between a quantity of radiated light of a first narrow band light source having a largest quantity of radiated light, and a quantity of radiated light of a final narrow band light source having a smallest quantity of radiating light.

17. The illumination device according to claim 2, wherein the narrow band light sources are sequenced in descending order of quantity of radiated light, and when a quantity of radiated light of a first narrow band light source having a largest quantity of radiated light is larger than a sum of quantities of radiated light of the other narrow band light sources, the first narrow band light source is directly connected to the second light combiner without being grouped.

18. The illumination device according to claim 6, wherein the narrow band light sources are distributed first from a group including narrow band light sources having a larger average quantity of radiated light.

19. The illumination device according to claim 1, wherein narrow band light sources included in a group are equally distributed, into the number of the primary light combiners, to the primary light combiners from narrow band light sources in descending order of quantity of radiated light, and remaining narrow band light sources are distributed with priority from a primary light combiner to which a narrow band light source having a small quantity of radiated light is distributed in a first distribution.

20. The illumination device according to claim 1, wherein to one or more of the primary light combiners to which narrow band light sources in a first group are more distributed than other one or more primary light combiners, narrow band light sources of a second group are less distributed than the other one or more primary light combiners, or
wherein to a primary light combiner to which narrow band light sources in a first group are distributed so as to have a larger quantity of entering light than quantities of entering light of other one or more primary light combiners, narrow band light sources in a second group are distributed so as not to have a quantity of entering light other than the quantities of entering light of the other one or more primary light combiners.
